(19) United States
(12) Patent Application Publication
(10) Pub. No.: US 2019/0011300 A1
(43) Pub. Date: Jan. 10, 2019

(54) METHOD FOR OPERATING A FLUID METER, FLUID METER AND MOUNTING ADAPTER

(71) Applicants: DIEHL METERING GMBH, Ansbach (DE); DIEHL METERING S.A.S., Saint Louis (FR)

(72) Inventors: MAXIMILIAN GLOSS, SPENGE (DE); FELIX HIRNER, SCHWAEBISCH GMUEND (DE); KATHARINA VOSS, KARLSRUHE (DE); MAXIMILIAN WINTER, HEIDELBERG (DE); VALENTIN ZIMMERMANN, BRUCHSAL (DE); CONG MINH NGUYEN, KARLSRUHE (DE)

(21) Appl. No.: 16/001,005

(22) Filed: Jun. 6, 2018

(30) Foreign Application Priority Data
Jul. 8, 2017 (DE) 10 2017 006 494.6

(51) Int. Cl. G01F 1/66

(52) U.S. Cl. CPC G01F 1/668; G01F 1/662

(57) ABSTRACT

A method for operating a fluid meter, in particular a clamp-on fluid meter, in which a first measuring arrangement is arranged on a fluid-conducting pipe. Fluid flow quantity determination is carried out with the first measuring arrangement. A second measuring arrangement includes an ultrasound transducer that emits an ultrasound signal along a second measurement path. The signal is reflected at the pipe in the direction of the ultrasound transducer. The second measurement path is substantially orthogonal to the pipe and/or flow direction of the fluid. The time of flight of the ultrasound signal along the second measurement path is determined and changes in the flow cross section are found based on the time of flight of the ultrasound signal along the second measurement path. A correction of the first measuring arrangement is carried out with the aid of the changes in the flow cross section.

### CROSS-REFERENCE TO RELATED APPLICATION

This application claims the priority, under 35 U.S.C. § 119, of German patent application DE 10 2017 006 494.6, filed Jul. 8, 2017; the prior application is herewith incorporated by reference in its entirety.

### BACKGROUND OF THE INVENTION

### Field of the Invention

The present invention pertains to a method for operating a fluid meter, in particular a clamp-on fluid meter, in which a first measuring arrangement is arranged on a pipe through which fluid flows, the first measuring arrangement is assigned a first measurement path, a flow quantity determination of the fluid is carried out with the aid of the first measuring arrangement, and a second measuring arrangement, which comprises an ultrasound transducer is provided. The ultrasound transducer emits an ultrasound signal along a second measurement path, which signal can preferably be reflected at the pipe in the direction of the ultrasound transducer, the second measurement path is substantially orthogonal to the pipe and/or flow direction of the fluid, and the time of flight of the ultrasound signal along the second measurement path is determined. The invention also relates to a fluid meter and to a mounting adapter for a fluid meter.

Fluid meters are preferably used as water meters for determining the flow quantity of water, or the drinking water consumption, in households or businesses or as heat quantity meters for determining the heat energy consumed.

The flow quantity determination may for example be carried out mechanically (for example by a vane wheel water meter), magnetically/inductively or by means of an ultrasound measuring arrangement (for example by an ultrasonic fluid meter). The functionality of an ultrasonic fluid meter is based on the use of ultrasound transducers, in particular piezoelectric ultrasound transducers. In that case, for example, two ultrasound transducers form an ultrasound transducer pair, with a measurement path lying between the ultrasound transducers. Along the measurement path, ultrasound waves or ultrasound signals, particularly in the form of so-called ultrasound bursts, may be emitted and received by the ultrasound transducers. The measurement path may in this case have a very wide variety of shapes. For example, it may be configured to be rectilinear or, because of deviations at reflectors or mirrors, U-shaped, zigzag-shaped or curved.

Fluid meters typically have a connection housing with an inlet and an outlet, by means of which the fluid meter can be installed in the pipe of a fluid line network, for example a drinking water pipe. To this end, the pipe needs to be opened so that the ultrasonic fluid meter can be fitted into it. The installation outlay and the installation time are correspondingly great.

Compared with this, ultrasonic fluid meters are also known which can be fitted externally onto the pipe, so-called clamp-on fluid meters. Such clamp-on fluid meters can emit sound through the pipe and in this way determine the flow quantity of the fluid flowing therein. However, this type of fluid meter has the disadvantage that calibration of the clamp-on fluid meter must be carried out in situ, in order to ensure that the fluid meter is metrologically adapted to the respective installation situation on site. To this end, the cross section of the pipe through which fluid flows generally needs to be measured by hand. This method is inaccurate and susceptible to error. Problems therefore arise in respect of standardising the fluid meter, so that such fluid meters cannot be standardised on any desired already installed pipes. To this end, the respective pipes would need to be replaced by jointly standardised pipes. Furthermore, changes due to operation, for example deposits on the pipe, can lead to a change in the flow cross section, and therefore impair the measurement accuracy of the fluid meter in the course of the operating time (measurement drift).

U.S. Pat. No. 5,533,408 and its counterpart European Patent EP 0 686 255 B1 discloses a clamp-on ultrasonic flow meter for installation on a pipe, which determines the volume flow rate with the aid of a first and a second pair of ultrasound transducers. This ultrasonic flow meter furthermore has an additional ultrasound transducer, which is used to determine the orthogonal time of flight of the ultrasound signal inside the wall of the pipe and the orthogonal time of flight of the ultrasound signal which propagates from the ultrasound transducer through the fluid and is reflected at the pipe inner wall opposite the ultrasound transducer. Furthermore, a circumferential signal is established with the aid of the measured pipe circumference, and a speed-of-sound signal is established with the aid of the known speed of sound for the material of the pipe. From the two orthogonal times of flight, the circumferential signal and the speed-of-sound signal, the wall thickness of the pipe and the speed of sound in the fluid are subsequently determined, from which the internal diameter of the pipe can be derived. The fluid meter has the disadvantage that contamination and deposits on the pipe wall of the pipe make the flow cross section smaller over the course of time and therefore reduce the measurement accuracy. With increasing contamination of the pipe, a drift in the measurement accuracy therefore occurs, which has an impact on the durability or long-term stability, or measurement stability. Furthermore, the speed of sound of the fluid is used as a parameter for determining the internal diameter. The speed of sound of the fluid, however, is subjected to large variations, which can have a detrimental effect on the measurement result.

### BRIEF SUMMARY OF THE INVENTION

It is an object of the invention to provide a clamp-on fluid meter and a method which overcome a variety of disadvantages of the heretofore-known devices and methods of this general type and of the present invention is to provide a method for operating a fluid meter of the generic type, in which the measurement accuracy and measurement stability are improved.

With the foregoing and other objects in view there is provided, in accordance with the invention, a method for operating a fluid meter, the fluid meter having a first measuring arrangement disposed on a pipe through which fluid flows, the method comprising:

determining a flow quantity of the fluid with the first measuring arrangement, the first measuring arrangement having assigned a first measurement path;

providing a second measuring arrangement with an ultrasound transducer and emitting with the ultrasound transducer an ultrasound signal along a second measurement path, the second measurement path being substantially orthogonal to the pipe and/or to a flow direction of the fluid, and wherein the signal is reflected at the pipe in a direction of the ultrasound transducer;

determining a time of flight of the ultrasound signal along the second measurement path and determining changes due to operation in a flow cross section from the time of flight of the ultrasound signal along the second measurement path; and

effecting a correction of the first measuring arrangement based on the changes in the flow cross section due to operation.

In other words, according to the invention, changes due to operation in the flow cross section, for example because of contamination or deposits in the region of the pipe wall, are determined with the aid of the time of flight of the ultrasound signal along the second measurement path. Subsequently, a correction of the first measuring arrangement is carried out with the aid of the changes in the flow cross section due to operation which have been determined. That is, the second measurement aids in the calibration of the actual fluid flow measurement. The pipe is in this case measured by means of ultrasound, or by means of a pulse-echo method. This preferably allows integrated and continuous determination of the flow cross section, in which besides the initial determination of the pipe internal diameter or of the flow cross section, a change in the flow cross section due to operation is also recorded, i.e. continuous noninvasive determination of the pipe internal diameter as well as deposit detection (contamination determination or condition monitoring) can be carried out in parallel. The values thereby recorded may be used for installation, maintenance and/or calibration of the fluid meter, so that the measurement accuracy and measurement stability of the fluid meter can be improved significantly. For example, the settings for control of the first measuring arrangement, for example the frequency and/or intensity of the ultrasound signal of the first measuring arrangement, may thereby be adapted to the respective measurement situation, i.e. the flow cross section currently existing or changed due to operation.

The term “substantially” as used herein should allow a deviation of a few percent, namely, so that the deviation does not have any, or only a negligible, impact on the resulting measurement and/or parameter calculation.

Expediently, the current flow cross section, or the flow cross section changed due to operation, of the pipe may be determined with the aid of the speed of sound of the fluid and the time of flight of the ultrasound signal along the second measurement path.

Preferably, the ultrasound transducer of the second measuring arrangement emits the ultrasound signal or emission signal orthogonally to the flow direction of the fluid along the second measurement path. In order to determine the changes in the flow cross section due to operation, it is possible to use a reception signal which is composed of reflection components of the emission signal in relation to a reflection of the emission signal at various interfaces (interfacial reflections), for example the interface between inner pipe wall and deposit, and/or the interface between deposit and fluid layer, and/or the interface between fluid layer and opposite deposit, and/or the interface between opposite deposit and opposite inner pipe wall, and/or the outer pipe wall. By detection of the reflected signals or signal components and/or the time of flight thereof, the accurate location or position of the interfaces can be determined, so that for example the layer thickness of the deposits and therefore, for example, the degree of contamination can also be determined. Maintenance intervals can thereby be adapted individually to the respective installation situation. The durability and measurement stability of the fluid meter is thereby improved to a particular extent. Furthermore, the emission signal may also be reflected at material boundaries inside a layer. In addition, besides the change in the flow cross section, a deposit occurring only on one side inside the pipe may also be detected by determining the position of the interfaces.

Furthermore, the variations in the flow cross section due to operation may be recorded and stored as a function of time. This leads to the advantage that a profile may be recorded, with the aid of which it is possible to determine events which have caused contamination. Furthermore, maintenance and cleaning intervals can be adapted. The durability and measurement stability of the fluid meter are thereby improved to a particular extent

Preferably, a determination of the temperature of the fluid, or the fluid temperature, is carried out, the fluid temperature being used for parameter correction, in particular for correction of the speed of sound and/or of the flow quantity of the fluid. Because the fluid temperature has a great influence on the measurement accuracy, the effect achieved by a temperature correction of the measurement values is that the measurement accuracy and also the measurement stability are improved even further.

Expediently, the determination of the temperature of the fluid can be carried out with the aid of the first measuring arrangement. To this end, for example when there is no fluid flow (for example during installation), an ultrasound signal or a pulse may be emitted along the first measurement path, and the time of flight of this ultrasound signal may subsequently be determined. During installation of the fluid meter, both the path which the ultrasound signal must travel and the corresponding time of flight, which is required to travel this path, are known, so that the determination of the temperature of the fluid can be carried out with the aid of these values.

Preferably, the temperature of the fluid is in this case determined by comparing the measured time of flight with the time of flight of an empirically determined table (look-up table), which contains the time of flight as a function of the temperature of the fluid. The corresponding temperature may therefore be determined with the aid of the measured and stored times of flight, or of the derived time-of-flight difference between the measured and empirically determined time of flight, for example by reading the look-up table.

As an alternative or in addition, the temperature of the pipe and the ambient temperature may be determined in order to determine the temperature of the fluid. Subsequently, the fluid temperature may be determined or calculated with the aid of a thermodynamic model of the system.

According to one preferred configuration, the determination of the pipe temperature and/or the ambient temperature may be carried out with two temperature sensors, the pipe temperature being recorded with a first temperature sensor and the ambient temperature with a second temperature sensor, which are for example arranged in the region of the fluid meter and/or the pipe.

Preferably, an ultrasound measuring arrangement having at least one ultrasound transducer for emitting and/or receiving ultrasound signals along the first measurement path is provided as the first measuring arrangement. The flow quantity determination of the fluid is preferably carried out here with the aid of a time-of-flight measurement of the ultrasound signals of the ultrasound measuring arrangement (for example time-of-flight difference method, drift method and/or Doppler method).

Expediently, a calibration function, preferably to be carried out autonomously by the fluid meter, for calibrating the first measuring arrangement may be provided. In particular, the calibration of the first measuring arrangement may be carried out with the aid of the values of the second measuring arrangement which have been determined, so that the fluid meter can be calibrated autonomously, or automatically (self-calibration function). This enables the fluid meter to autonomously counteract a measurement drift, for example due to deposits in the pipe or erosion of the latter. The calibration may in this case be initialised and/or carried out autonomously by the fluid meter, or its control and evaluation unit, at particular time intervals. In this way, for example, the measurement deviations caused by deposits and/or temperature variations may be reduced. The measurement accuracy and measurement stability are thereby improved to a particular extent. Furthermore, it is conceivable for externally acting initialisation, remotely controlled for example by the control centre of the supplier, of the calibration function to be provided.

Furthermore, a degree of contamination determination may be provided, the degree of contamination being determined with the aid of the flow cross section of the pipe changed due to operation, and/or the position of the interfaces. The degree of contamination determination is used, for example, to inform the user of the current degree of contamination, for example by means of a display at or remote from the fluid meter, or downstream monitoring software which is supplied with the contamination-related data of the fluid meter, for example via radio. This leads to the advantage that the current degree of contamination of the fluid meter can always be accessed, and steps for removal, for example cleaning or replacement of the fluid meter, can therefore be instigated promptly. Furthermore, the degree of contamination determination may comprise an alarm function.

Expediently, the frequency of the ultrasound signal, reflected at the inner and/or outer pipe wall, or of the reflected signal components of the ultrasound signal, of the second measuring arrangement may be determined. The time of flight of the ultrasound signal in the wall of the pipe may in turn be determined with the aid of this frequency, whereby e.g. the wall thickness of the pipe may be determined. For example, in that the known quantities of external circumference of the pipe and speed of sound in the material of the pipe and the time of flight of the ultrasound signal which has been determined are used for calculating the wall thickness. The wall thickness may subsequently be used as an additional parameter for the flow cross section and/or flow quantity determination. The measurement accuracy is thereby improved even further.

Furthermore, the method may comprise at least one of the method steps of generation of a reflection signal, determination of a backwall echo, determination of the start of the backwall echo, determination of the frequencies contained in the backwall echo, and/or calculation of the time of flight from the frequencies which have been determined.

Expediently, a third measuring arrangement having at least one ultrasound transducer may be provided. The ultrasound transducer may in the same way emit an ultrasound signal along a third measurement path. The third measurement path may in this case, for example, lie between the ultrasound transducer and the inner pipe wall and extend obliquely or orthogonally to the second measurement path. For example, this may be done by the ultrasound transducer of the third measuring arrangement being offset along the circumference of the pipe by an angle, for example of 90°, relative to the ultrasound transducer of the second measuring arrangement. With the aid of the time of flight of the ultrasound signal along the third measurement path, changes due to operation in the flow cross section may therefore be determined in an additional measurement direction, for example extending orthogonally to the measurement direction of the second measuring arrangement.

Preferably, a check and/or change of the measurement values of the second measuring arrangement, for example by averaging, may be carried out with the aid of the measurement values of the third measuring arrangement. This leads to the advantage that a plausibility check of the measurement values of the second measuring arrangement can be carried out. Furthermore, it is possible to determine whether the contaminations along the pipe wall are formed radially symmetrically or arranged nonuniformly distributed. These measurement values may advantageously be used for correcting the measurement values of the first and/or second measuring arrangement.

With the above and other objects in view there is also provided, in accordance with the invention, a fluid meter for determining the flow quantity by way of the method summarized above. The fluid meter comprises:

a first measuring arrangement having a first measurement path for flow quantity determination;

a second measuring arrangement, having an ultrasound transducer configured to emit and/or receive an ultrasound signal along a second measurement path, the second measurement path extending substantially orthogonal to a longitudinal direction of the pipe and/or a flow direction of the fluid; and

a control and evaluation unit connected to said first and second measuring arrangements and configured to determine a time of flight of the ultrasound signal along the first measurement path and along the second measurement path;

said control and evaluation unit being configured, in concert with said first and second measuring arrangements, to determine a flow quantity of the fluid in the pipe, to determine a time of flight of the ultrasound signal along the second measurement path and determine changes due to operation in a flow cross section from the time of flight of the ultrasound signal along the second measurement path; and

said control and evaluation unit being configured to effect a correction of the first measuring arrangement based on the changes in the flow cross section in the pipe.

In other words, the present invention independently claims a fluid meter, in particular a clamp-on fluid meter, for determining the flow quantity inside a pipe, which fluid meter comprises a first measuring arrangement having a first measurement path for flow quantity determination, and a second measuring arrangement having at least one ultrasound transducer. The ultrasound transducer is configured to emit and/or receive an ultrasound signal along a second measurement path. The second measurement path is in this case preferably located between the ultrasound transducer and the pipe wall, or between the ultrasound transducer and a further ultrasound transducer of the second measuring arrangement. Furthermore, a control and evaluation unit is provided, by means of which the time of flight of the ultrasound signal along the first and/or second measurement path can be determined. The ultrasound transducer of the second measuring arrangement is configured to receive an ultrasound signal which is reflected at an interface inside the pipe, the time of flight of the ultrasound signal between the ultrasound transducer and the interface being determined by the control and evaluation unit and subsequently used for position determination of the interface. Preferably, an ultrasound measuring arrangement having at least one ultrasound transducer for emitting and/or receiving ultrasound signals along the first measurement path is provided as the first measuring arrangement. The flow quantity determination of the fluid is carried out, for example, with the aid of a time of flight measurement of the ultrasound signals of the ultrasound measuring arrangement, for example with the aid of a time-of-flight difference method.

Furthermore, in order to determine or measure the temperature of the pipe and the ambient temperature, temperature sensors may be provided, which are preferably arranged or mounted in the region of the fluid meter or of the pipe.

Preferably, there is also provided a mounting adapter, which receives the component parts of the fluid meter, in particular the first measuring arrangement, the second measuring arrangement and/or the control and evaluation unit. The fluid meter can be fitted in a straightforward way on the pipe by means of the mounting adapter. In this case, the mounting adapter ensures guiding and protection of all modules placed on the pipe, for example ultrasound transducers, sensors or the like, as well as correct mounting thereof.

Furthermore, the present invention independently claims a mounting adapter for a fluid meter particular, in particular for a clamp-on fluid meter, which comprises an adapter part, which has a pipe half-shell geometry that is preferably adapted to the contour of the pipe. Furthermore provided are at least one fastening means, which is fitted on the adapter part for fastening the adapter part on the pipe, and at least one receiver for receiving the first and/or second measuring arrangement and/or the control and evaluation unit. The mounting adapter furthermore comprises a damping and/or sealing element, which is provided between the pipe and the adapter part and therefore decouples or separates the adapter part and the pipe. The mounting adapter offers the fluid meter a defined and load-bearing docking position and furthermore significantly simplifies the mounting process. Furthermore by a mounting adapter configured in such a way, the measurement position in the pipe is established and no longer displaceable, i.e. the arrangement of the component parts of the fluid meter can be made uniform, like for example the distance between the ultrasound transducers of the first measuring arrangement. This leads to the advantage that the measurement stability and measurement accuracy are improved to a particular extent. Furthermore, the component parts may be prefabricated as a unit in the factory. This shortens the mounting time. In addition, by poka-yoke measures, for example key/lock principle insertion solutions, it is possible to prevent the mounting adapter from being incorrectly installed. In this way, the mounting is simplified significantly and the operational reliability is increased.

Expediently, the damping and/or sealing element may have a coupling means for coupling the ultrasound transducer, for example the ultrasound transducer of the first and/or second measuring arrangement, onto the pipe. The entry of the ultrasound signals into the pipe or pipe wall is thereby improved.

Other features which are considered as characteristic for the invention are set forth in the appended claims.

Although the invention is illustrated and described herein as embodied in a method for operating a fluid meter, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE SEVERAL VIEWS OF THE DRAWING

FIG. 1 shows a simplified schematic sectional representation of a first configuration of a fluid meter according to the invention;

FIG. 2 shows a simplified schematic sectional representation of a further configuration of the fluid meter according to the invention;

FIGS. 3A-3E show five simplified schematic sectional representations of the second measuring arrangement of the fluid meter of FIG. 2;

FIG. 4 shows a simplified schematic representation of the time profile of the increase in the degree of contamination and correction factor;

FIG. 5 shows a simplified representation of the profile of the speed of sound as a function of the temperature of a fluid;

FIG. 6A shows a simplified schematic sectional representation of a further configuration of the fluid meter according to the invention and FIG. 6B shows a cross-section through an alternative embodiment; and

FIG. 7 shows a simplified perspective representation of a further configuration of the fluid meter according to the invention with a mounting adapter.

### DETAILED DESCRIPTION OF THE INVENTION

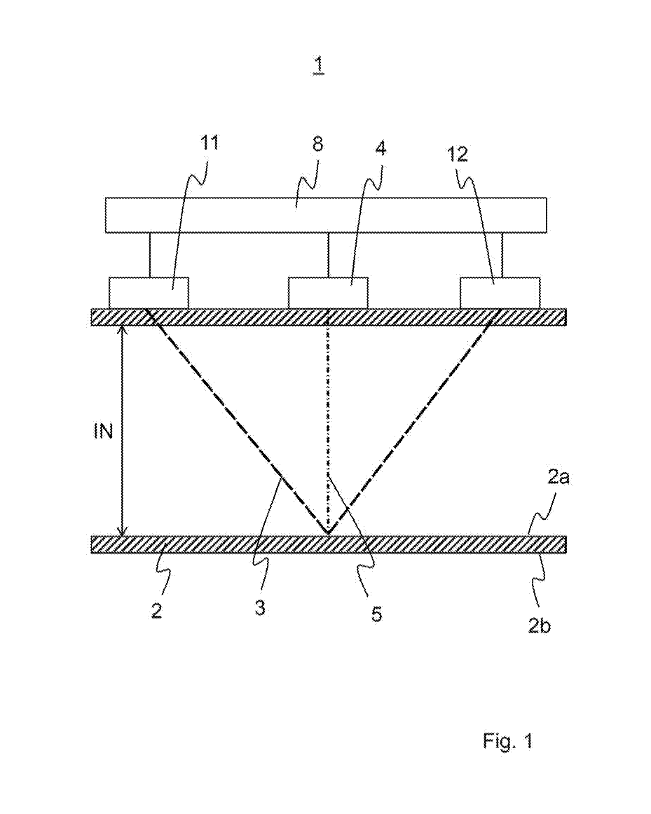

Referring now to the figures of the drawing in detail and first, particularly, to FIG. 1 thereof, there is shown a clamp-on fluid meter 1 according to the invention shortly after installation has been carried out. The clamp-on fluid meter 1 is arranged, for example clamped or screwed, on a pipe 2 through which a fluid flows, i.e. no measuring means of the clamp-on fluid meter 1 are in contact with the fluid. For flow quantity determination of the fluid, the clamp-on fluid meter 1 comprises a first measuring arrangement, which is formed as an ultrasound measuring arrangement having two ultrasound transducers 11, 12. The ultrasound transducers 11, 12 are fitted on the pipe 2, the measurement sound being introduced through the pipe wall with the pipe wall surfaces 2a and 2b. The pipe wall surfaces 2a, 2b will be referred herein as pipe walls for short. Between the two ultrasound transducers 11, 12, there is a V-shaped first measurement path 3, which is turned around at the inner pipe wall 2a of the pipe 2. The ultrasound transducers 11, 12 are in this case controlled by a superordinate control and evaluation unit 8. The clamp-on fluid meter 1 furthermore comprises a second measuring arrangement having an ultrasound transducer 4, inter alia for determining the internal diameter IN of the pipe 2. To this end, the ultrasound transducer 4 emits ultrasound signals along a second measurement path 5. These ultrasound signals are reflected at the pipe 2 in the direction of the ultrasound transducer 4 and received by the ultrasound transducer 4. The internal diameter IN of the pipe 2 can subsequently be determined from the time of flight of this ultrasound signal.

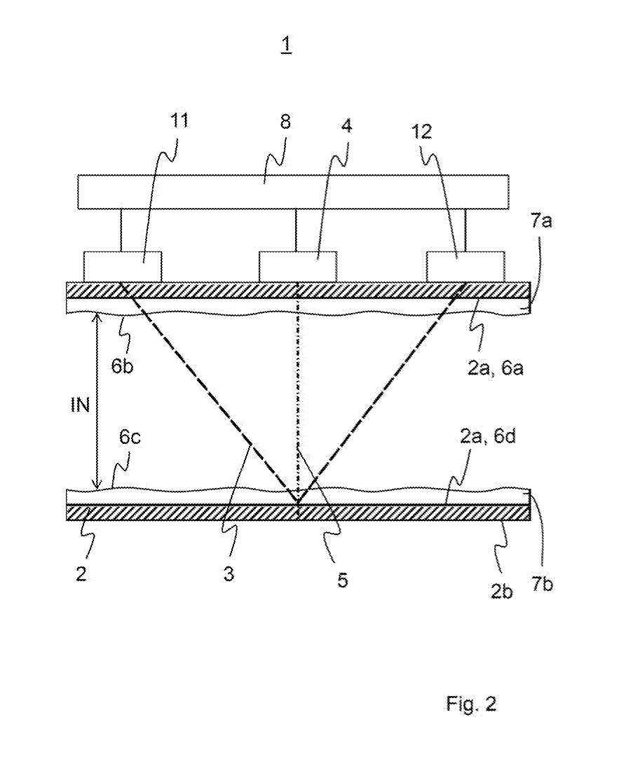

FIG. 2 shows a clamp-on fluid meter 1 which is in operation and has already been contaminated, and which is operated with the method according to the invention. The clamp-on fluid meter 1 comprises a first measuring arrangement for flow quantity determination and a second measuring arrangement for determining the internal diameter IN of the pipe 2 and for determining the changes due to operation in the flow cross section.

The determination of the internal diameter IN, or of the flow cross section, is carried out with the aid of a pulse-echo measurement. To this end, the ultrasound transducer 4 is excited with a sharp voltage pulse. The ultrasound transducer 4 thereupon emits an ultrasound signal along the second measurement path 5, which is reflected at the pipe wall 2a (generation of a reflection signal) and subsequently in turn received by the ultrasound transducer 4, i.e. the reception signal or the echo. In order to process the ultrasound signal, it is initially filtered, for example by means of a highpass and/or lowpass filter. The signal is subsequently split. This is used to reduce the likelihood of error by not taking into account the samples of the signal, or signal components, which in no case contain information about the echo of the pipe wall surface 2a. This produces a cut signal in which the echo can be looked for, for example by means of a predetermined threshold value (determination of a backwall echo). Both the start and the frequency or frequencies are determined from this echo. From the start, the time of flight between the ultrasound transducer 4 and the opposite inner pipe wall surface 2a and/or the outer pipe wall surface 2b can be determined. From the frequencies, in turn, the time of flight of the signal in the pipe wall can be calculated (calculation of the time of flight from the frequency determined or the frequencies determined). With the aid of these values, the flow cross section can be determined mathematically.

Furthermore, there are deposits 7a, 7b on the inner pipe wall 2a of the pipe 2, which have been formed due to operation over a particular length of usage of the fluid meter. Such deposits 7a, 7b may negatively influence the measurement accuracy and measurement stability, for example by the flow cross section being reduced. For this reason, for example, the current flow cross section may deviate over the operating time from the internal diameter IN of the pipe 2 determined at the installation time. For example, the first measurement section 3 may be shortened and/or shifted by a widening deposit layer.

The position and layer thickness of the deposits 7a, 7b are determined in the method according to the invention with the aid of the time of flight of the ultrasound signal along the second measurement path 5, by the pipe 2 being measured over the second measurement path 5 by means of a pulse-echo. The layer transitions between the deposits 7a, 7b, the fluid layer and the pipe wall 2a in this case constitute interfaces at which the ultrasound signal of the ultrasound transducer 4 is reflected. For the determination of the position and layer thickness of the deposits 7a, 7b, in particular the components of the ultrasound signal reflected at the interface 6a between the inner pipe wall 2a and the deposit 7a, the interface 6b between the deposit 7a and the fluid layer, the interface 6c between the fluid layer and the opposite deposit 7b, and the interface 6d between the opposite deposit 7b and the opposite inner pipe wall 2a are used. Reflections may, however, also occur at the outer pipe wall 2b and material transitions inside the layers, the respective position of which may also be determined by the method.

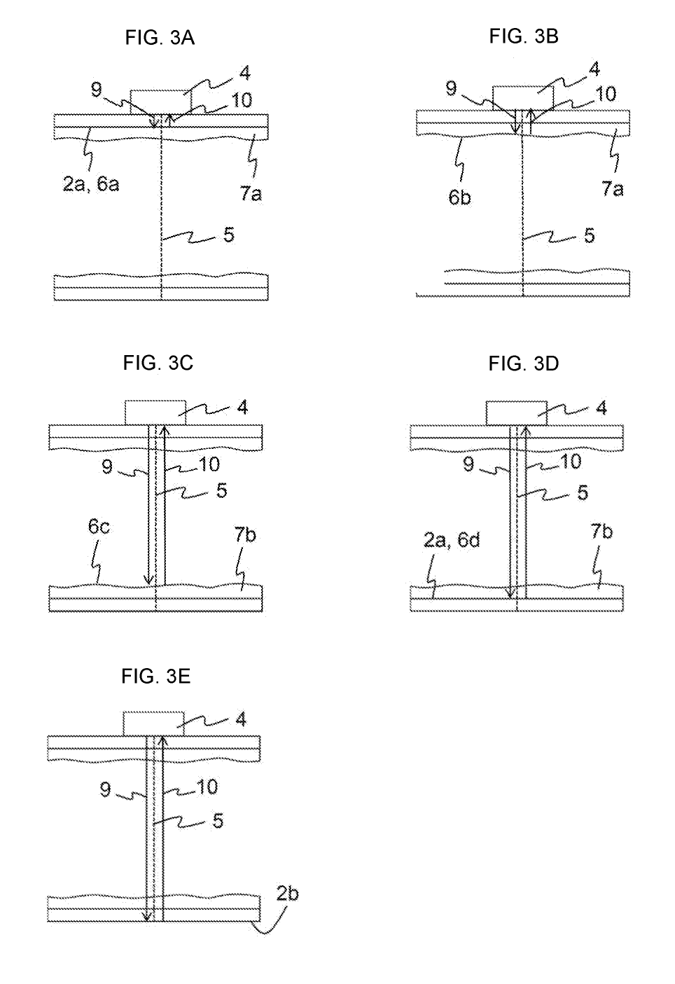

According to FIGS. 3A-3E, the ultrasound transducer 4 of the second measuring arrangement first emits an ultrasound signal, or an emission signal 9, which travels along the second measurement path 5 orthogonally to the flow direction of the fluid. As shown in FIGS. 3A-3E, this emission signal 9, or parts of the emission signal 9, is or are reflected at the interfaces 6a, 6b, 6c, 6d. In this case, reflections take place at the interfaces 6a (FIG. 3A), 6b (FIG. 3B), 6c (FIG. 3C), 6d (FIG. 3D) and the outer pipe wall 2b (FIG. 3E). The time of flight of the ultrasound signal, or of the emission signal 9, and/or of the reception signal 10 may in this case be used for position determination of the respective interface 6a, 6b, 6c, 6d, so that a profile section of the pipe 2 together with the deposits 7a, 7b can be formed.

Furthermore, by means of the known speed of sound in the fluid, for example the speed of sound in water, and the time-of-flight difference of the times of flight of the ultrasound signal along the second measurement path 5 between the ultrasound transducer 4 and the interface 6b and of the ultrasound signal between the ultrasound transducer 4 and the interface 6c, the respective current flow cross section can be determined.

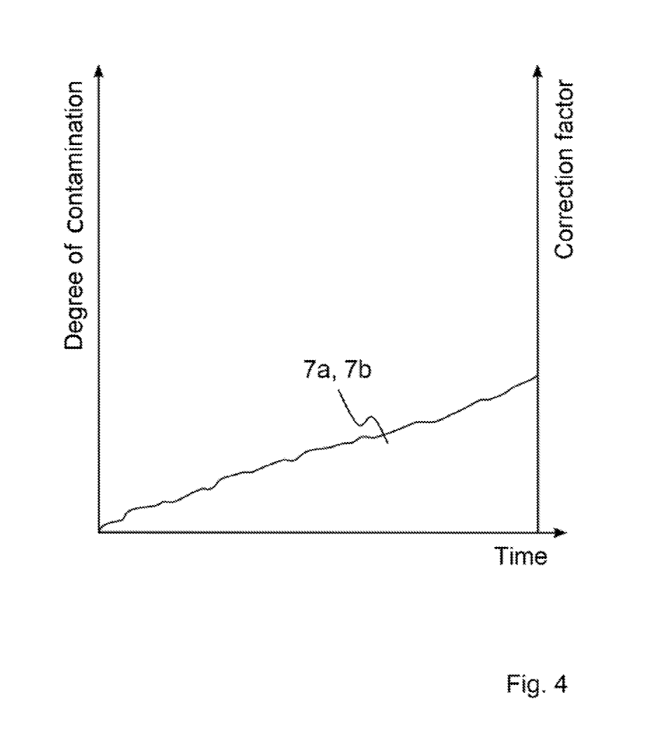

A predetermined layer thickness of the deposits 7a, 7b may, for example, be used as a measure or limit value for a particular degree of contamination. In this way, maintenance intervals can be adapted individually to the respective contamination situation. Furthermore, autonomous correction or calibration of the first measuring arrangement is carried out with the aid of the changes in the flow cross section which have been determined, or of the values recorded by the second measuring arrangement, for example by the settings of the control and evaluation device 8 for controlling the first measuring arrangement, for example the frequency and/or intensity of the ultrasound signal, being adapted to the respective measurement situation, or the current flow cross section. This may, for example, be done by means of a correction factor. In FIG. 4, the increase in the correction factor as a function of time, and the associated increase in the deposits 7a, 7b or in the deposit thickness, are represented.

Furthermore, the changes in the flow cross section may also be recorded over a longer period of time and stored in a memory device (not represented in the figures). This leads to the advantage that a profile can be recorded, with the aid of which events that have caused contamination can be determined. Furthermore maintenance and cleaning intervals can be adapted to the actual requirement. The durability and measurement stability of the clamp-on fluid meter 1 is thereby additionally improved. Expediently, the flow cross sections measured in the course of time may be stored in the memory as a database. By means of this database, measured values may be verified. If a very large deviation of the values of the internal diameter IN is then established, the system may be configured in such a way that a second independent measurement is carried out. Measurement errors may be minimised by this plausibility check.

As an alternative to the configurations of FIGS. 2 and 3, it is also possible to provide an additional ultrasound transducer of the second measuring arrangement. In that case, the additional transducer would for example be arranged on the side of the pipe 2 opposite the ultrasound transducer 4 and would likewise be able to emit and receive ultrasound signals along the second measurement path 5.

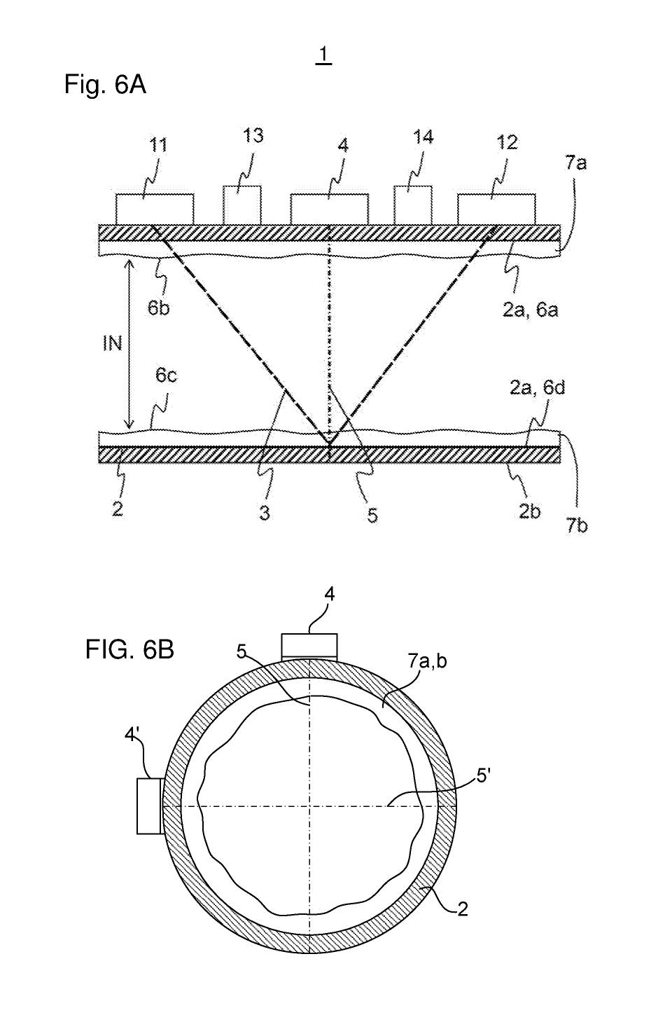

As indicated in FIG. 6B, yet another ultrasound transducer of a third measuring arrangement may also be provided. The transducer 4′ is illustrated opposite the transducer 4 (i.e., with an offset of 180°). In a preferred embodiment, however, it is offset along the pipe 2 by 90° relative to the ultrasound transducer 4 of the second measuring arrangement. Correspondingly, a further third measurement path 5′, for example extending orthogonally to the second measurement path 5, could be arranged between this ultrasound transducer and the pipe 2. With the aid of the measurement values of the third measuring arrangement, for example, a plausibility check of the measurement values of the second measuring arrangement may be carried out. Furthermore it is possible to determine whether the pipe 2 is radially symmetrical and whether the contamination is contamination extending radially symmetrically, i.e. uniformly, along the inner pipe wall 2a, or nonuniformly extending contamination.

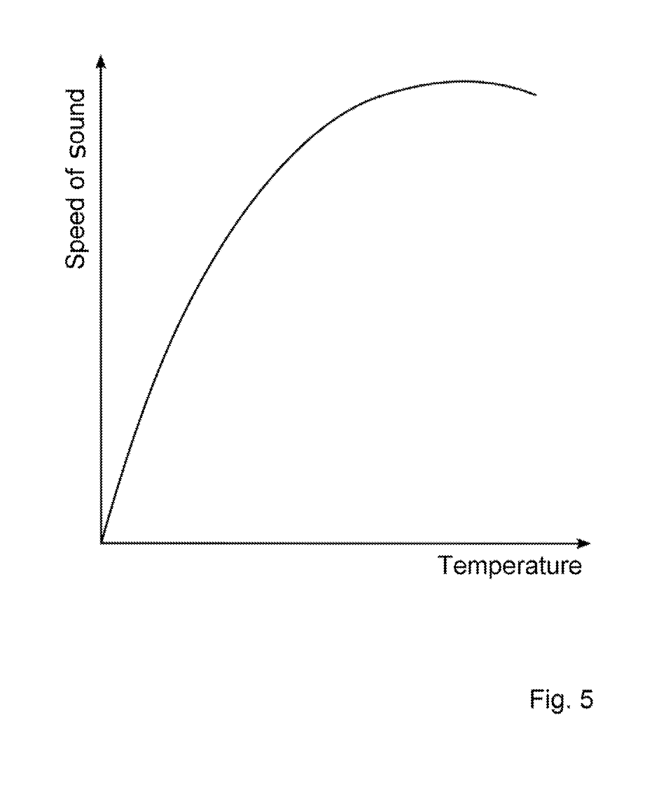

Furthermore, other parameters, for example the temperature of the fluid may also influence the measurement accuracy of the fluid meter. For example because the speed of sound in the fluid, or in the water, is a temperature-dependent quantity. In FIG. 5, the speed of sound in water as a function of the water temperature is represented. Deviations of the fluid temperature therefore have a direct effect on the speed of sound, and therefore also on the measurement accuracy of the fluid meter, or of the flow quantity determination. The speed of sound differs at different temperatures as a percentage from a reference value. For example, 20° C. may be set as the reference value. The speed of sound may deviate by more than 1% even at 15° C. In order to minimise the effects of these uncertainties in the speed of sound on the measurement result, various temperature models are proposed which may be used to correct the flow quantity determination and/or flow cross section determination.

One possibility for the temperature measurement consists in determining the temperature by using the already present ultrasound transducers 11, 12 of the first measuring arrangement for determining the flow quantity of the flowing fluid. In this case, for example during installation when there is not yet any flow of water, a pulse or an ultrasound signal is emitted which propagates along the first measurement path 3 between the ultrasound transducers 11, 12. The time of flight of this ultrasound signal is determined, the path which the signal must travel and the corresponding time of flight being known, so that the temperature can be determined directly. For example, this may be done by means of a look-up table stored in the control and evaluation electronics 8. The corresponding data are then stored in the system. For the next temperature measurement, the time of flight is determined again. Because of deposits in the pipe, for example, the time of flight may be reduced. With the aid of the initial value of the path and the newly determined time of flight, the temperature may subsequently be deduced.

As an alternative or in addition, as shown in FIG. 6A, two additional temperature sensors 13, 14 may be arranged on the pipe 2, which are provided in order to measure the temperature of the environment as well as the temperature of the tube, or of the pipe 2. Subsequently by means of a thermodynamic model the fluid temperature may be calculated by first determining the Prandtl number with the aid of the pipe temperature. With the aid of the Prandtl number, the fluid temperature may be calculated computationally. In order to increase the accuracy of this model, for example, a calculation loop may be initialised, which determines the fluid temperature and on the basis thereof recalculates the fluid temperature continually. At each iteration of the calculation loop, a check is then made as to how greatly the temperature determined deviates from its preceding temperature value. If a particular limit, which may be established in advance, is in this case fallen below, the calculation loop begins again.

In addition, in the scope of the invention, additional means (not represented in the figures) may also be provided, for example pressure sensors which are used for pressure determination, so that a correction of the flow quantity determination and/or flow cross section determination and/or of the calibration of the fluid meter, and/or of the contamination detection may be carried out with the aid of the pressure which is determined. As an alternative or in addition, the pressure determination may also be carried out with the aid of the first and/or second measuring arrangement.

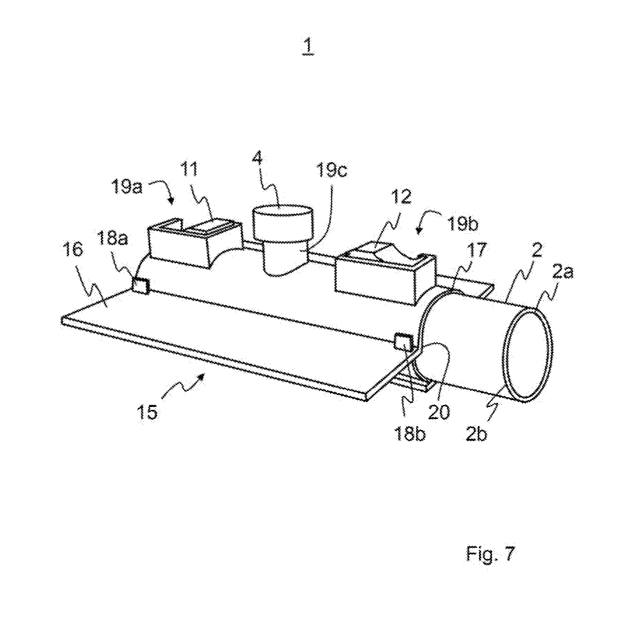

FIG. 7 represents a mounting adapter 15 for a clamp-on fluid meter 1, by means of which the clamp-on fluid meter 1 can be mounted on a pipe 2. The mounting adapter 15 comprises a substantially plate-shaped adapter part 16, which has a pipe half-shell geometry 17 that is preferably adapted to the contour of the pipe 2. The pipe half-shell geometry 17 may also be configured in such a way that it can be adapted to pipe types of different sizes, and for example to this end flexible or adjustable elements may be provided on the lower side. For example, such a mounting adapter 15 may be used for pipes having rated widths DN 1 to DN 10000, in particular DN 5 to DN 6000.

Furthermore, fasteners 18a, 18b for fastening the adapter part 16 on the pipe 2 are provided attached to the adapter part 16. For example, lashing straps, clips or buckles may be provided as fastening means 18a, 18b. In addition, receivers 19a, 19b, 19c, which receive the first and/or second measuring arrangement or parts thereof, are arranged on the upper side. The control and evaluation unit 8, for which a receiver may likewise be provided, is not represented for the sake of clarity in FIG. 7. Arranged between the pipe 2 and the adapter part 16, there is a damping and/or sealing element 20, which decouples or mutually separates the adapter part 16 and the pipe 2. The damping and/or sealing element 20 may furthermore comprise a coupling means (not represented in FIG. 7), which is intended to couple the ultrasound transducers 4, 11, 12 to the pipe 2, i.e. to establish contact between the ultrasound transducers 4, 11, 12 and the pipe 2, or the outer pipe wall 2b.

In summary, the clamp-on fluid meter 1 may preferably be calibrated autonomously by the determination of changes in the flow cross section due to operation, the pipe 2 in which the measurement is carried out no longer needing to be replaced or opened. Nevertheless, standardisation of the clamp-on fluid meter 1 can be achieved by the calibration on site.

Explicitly, the disclosure content also includes individual feature combinations (subcombinations) and possible combinations, not represented in the drawing figures, of individual features of different configurations.

The following is a summary list of reference numerals and the corresponding structure used in the above description of the invention:

1 clamp-on fluid meter

2 pipe

2a pipe wall (inner)

2b pipe wall (outer)

3 first measurement path

4 ultrasound transducer

4′ ultrasound transducer

5 second measurement path

5′ third measurement path

6a-6d interface

7a deposits

7b deposits

8 control and evaluation unit

9 emission signal

10 reception signal

11 ultrasound transducer

12 ultrasound transducer

13 temperature sensor

14 temperature sensor

15 mounting adapter

16 adapter part

17 pipe half-shell geometry

18a fastening means

18b fastening means

19a receiver

19b receiver

19c receiver

20 damping and/or sealing element

IN internal diameter (of the pipe)

1. A method for operating a fluid meter, the fluid meter having a first measuring arrangement disposed on a pipe through which fluid flows, the method comprising:
determining a flow quantity of the fluid with the first measuring arrangement, the first measuring arrangement having assigned a first measurement path;
providing a second measuring arrangement with an ultrasound transducer and emitting with the ultrasound transducer an ultrasound signal along a second measurement path, the second measurement path being substantially orthogonal to the pipe and/or to a flow direction of the fluid, and wherein the signal is reflected at the pipe in a direction of the ultrasound transducer;
determining a time of flight of the ultrasound signal along the second measurement path and determining changes due to operation in a flow cross section from the time of flight of the ultrasound signal along the second measurement path; and
effecting a correction of the first measuring arrangement based on the changes in the flow cross section due to operation.

2. The method according to claim 1, which comprises determining the flow cross section of the pipe, changed due to operation, with the aid of the speed of sound of the fluid and the time of flight of the ultrasound signal along the second measurement path.

3. The method according to claim 1, which comprises, in order to determine the changes in the cross section due to operation, using a reception signal that is composed of reflection components of the emission signal in relation to a reflection of the emission signal at a surface selected from the group consisting of:
an interface between an inner pipe wall and a deposit on the inner pipe wall;
an interface between the deposit and a fluid layer;
an interface between the fluid layer and an opposite deposit;
an interface between the opposite deposit and an opposite inner pipe wall; and
an outer pipe wall.

4. The method according to claim 1, which comprises recording variations in the flow cross section as a function of time.

5. The method according to claim 1, which comprises determining a temperature of the fluid, and using the temperature of the fluid for parameter correction selected from the group consisting of a speed of sound and a flow quantity of the fluid.

6. The method according to claim 5, which comprises determining the temperature of the fluid with the first measuring arrangement.

7. The method according to claim 5, which comprises determining the temperature of the fluid by comparing a measured time of flight with an empirically determined table, which contains the time of flight as a function of the temperature of the fluid.

8. The method according to claim 5, which comprises determining a temperature of the pipe and/or an ambient temperature and using the temperature for determining the temperature of the fluid.

9. The method according to claim 8, which comprises measuring the temperature of the pipe and/or the ambient temperature by way of temperature sensors, and calculating the temperature of the fluid therefrom.

10. The method according to claim 1, which comprises providing the first measuring arrangement as an ultrasound measuring arrangement having at least one ultrasound transducer for emitting and/or receiving ultrasound signals along the first measurement path, and determining the flow quantity of the fluid by way of a time-of-flight measurement of the ultrasound signals of the ultrasound measuring arrangement.

11. The method according to claim 1, which comprises providing the device with a calibration function, to be carried out autonomously by the fluid meter, for calibrating the first measuring arrangement, and carrying out the calibration with values determined by the second measuring arrangement.

12. The method according to claim 3, which comprises determining a degree of contamination from a determined flow cross section of the pipe changed due to operation and/or the position of the interface.

13. The method according to claim 1, which comprises determining a frequency of the ultrasound signal, reflected at the pipe wall, of the second measuring arrangement, and determining a time of flight of the ultrasound signal in the wall of the pipe based on the frequency.

14. The method according to claim 1, further comprising:
generating a reflection signal,
determining a backwall echo,
determining a start of the backwall echo,
determining frequencies contained in the backwall echo, and
calculating a time of flight of the reflection signal from the frequencies thus determined.

15. The method according to claim 1, which comprises providing a third measuring arrangement having at least one ultrasound transducer, emitting an ultrasound signal along a third measurement path with the at least one ultrasound transducer, and determining changes in the flow cross section due to operation from a time of flight of the ultrasound signal along the third measurement path.

16. The method according to claim 15, which comprises checking and/or changing the measurement values of the first and/or second measuring arrangement based on measurement values of the third measuring arrangement.

17. A fluid meter for determining the flow quantity inside a pipe, the fluid meter comprising:
a first measuring arrangement having a first measurement path for flow quantity determination;
a second measuring arrangement, having an ultrasound transducer configured to emit and/or receive an ultrasound signal along a second measurement path, the second measurement path extending substantially orthogonal to a longitudinal direction of the pipe and/or a flow direction of the fluid; and
a control and evaluation unit connected to said first and second measuring arrangements and configured to determine a time of flight of the ultrasound signal along the first measurement path and along the second measurement path;
said control and evaluation unit being configured, in concert with said first and second measuring arrangements, to determine a flow quantity of the fluid in the pipe, to determine a time of flight of the ultrasound signal along the second measurement path and determine changes due to operation in a flow cross section from the time of flight of the ultrasound signal along the second measurement path; and
said control and evaluation unit being configured to effect a correction of the first measuring arrangement based on the changes in the flow cross section in the pipe.

18. The fluid meter according to claim 17, which comprises temperature sensors disposed to measure a temperature of the pipe and an ambient temperature.

19. The fluid meter according to claim 17, configured as a clamp-on fluid meter that comprises a mounting adapter formed to receive component parts of the fluid meter and to mount the fluid meter on the pipe.

20. The fluid meter according to claim 19, wherein said mounting adapter is configured to receive the first measuring arrangement, the second measuring arrangement and the control and evaluation unit.

21. A mounting adapter for a fluid meter, comprising:
an adapter part having a pipe half-shell geometry adapted to a contour of a pipe;
at least one fastener which is fitted on said adapter part for fastening said adapter part on the pipe;
at least one receiver for receiving a first measuring arrangement, a second measuring arrangement and a control and evaluation unit of the fluid meter; and
a damping and/or sealing element configured to decouple and/or separate said adapter part from the pipe and disposed between the pipe and said adapter part.

22. The mounting adapter according to claim 21, wherein said damping and/or sealing element has a coupling device for coupling the ultrasound transducer onto the pipe.
